(19) United States
(12) Patent Application Publication
(10) Pub. No.: US 2009/0283068 A1
(43) Pub. Date: Nov. 19, 2009

(54) FUEL FILTER ASSEMBLY WITH PRESSURE SENDING UNIT

(76) Inventor: William L Willison, Royse City, TX (US)

Correspondence Address: AC Innovations LLC/Craig C. Conrad, 411 E. McDermott Drive, Allen, TX, 75002, US

(21) Appl. No.: 12/466,256

(22) Filed: May 14, 2009

Related U.S. Application Data
(60) Provisional application No. 61/127,493, filed on May 15, 2008.

(51) Int. Cl. F02B 1/12; F02M 69/00; G01M 15/04

(52) U.S. Cl. 123/27 R; 123/445; 701/29; 73/114.43

(57) ABSTRACT

A fuel filter assembly having a pressure sending unit for filtering and monitoring fuel and fuel pressure for diesel engines and the like comprising a filter head, a spin-on element and collection bowl. The filter head is fastened to an engine or other suitable structure by flange, bolts and supports the fuel filter assembly by monitoring fuel pressure by utilizing a pressure sending unit in fluid communication with an outlet port on the filter head. Preferably, filter head is a die cast head and includes therein typical inlet port, outlet port, and connected respectively thereto, inlet chamber and outlet chamber. Filter head is a generally circular structure having a flat annular mounting surface. The filter head may further comprises vent ports, vacuum switch ports or both, which are in fluid communication with outlet ports and return check valve ports that are in fluid communication with inlet ports. Still further, filter head is in fluid communication with a pressure sending unit, which is in electrical communication with a pressure monitoring device or similar warning system.

### RELATED APPLICATIONS

This application claims priority to U.S. Provisional Patent Application, Ser. No. 61/127,493, entitled “Fuel Filter Assembly with Pressure Sending Unit,” filed on May 15, 2008, the entire content of which is hereby incorporated by reference.

### FEDERALLY SPONSORED RESEARCH

Not Applicable.

### JOINT RESEARCH AGREEMENTS

Not Applicable.

### SEQUENCE LISTING

Not Applicable.

### BACKGROUND OF THE INVENTION

This invention generally relates to a fuel filter in combination with a pressure sending unit. More particularly, this invention relates to a fuel filter having a 2-5 micron filter in with a pressure sending unit that includes pressure sensing means therein for monitoring the condition of the fuel filter allowing a user to evaluate the buildup of residues and subsequent clogging of the fuel system filter. In a specific embodiment, the fuel filter in combination with a pressure sending unit is to be installed between the fuel transfer pump and the original manufacture equipped fuel filter.

A fuel filter is a sieve in the fuel line that screens out dirt and other particles from the fuel. They are found on most internal combustion engines. Fuel filters serve a vital function in engine fuel systems. Unfiltered fuel may contain several kinds of contamination, for example wax, asphaltines, or solid contaminants (e.g. paint chips and dirt that has been knocked into the tank while filling, or rust caused by moisture in a steel tank). If these substances are not removed before the fuel enters the system, they will cause rapid wear and failure of the fuel pump and injectors, due to the abrasive action of the particles on the high-precision components used in modern injection systems. Fuel filters also improve performance because fuel with fewer contaminant burn more efficiently.

Fuel filters need to be cleaned or changed when they are clogged, but current practice recommends cleaning or changing filters at regular intervals. Although some specially designed filters can be cleaned and reused many times, many other types of fuel filters need to be disconnected from fuel line and replaced. If a filter is not cleaned or replaced regularly it may become clogged with contaminants and cause a restriction in the fuel flow, which causes an appreciable drop in engine performance as the engine struggles to draw enough fuel to continue running normally.

Some filters, especially those found on diesel engines, are of a bowl-like design that collects water in the bottom (as water is denser than diesel). The water can then be drained off by opening a valve in the bottom of the bowl and letting it run out, until the bowl contains only diesel. It is especially undesirable for water to be drawn into a diesel engine fuel system, as the system relies on the diesel fuel for lubrication of the moving parts, and if water gets into a moving part which requires constant lubrication (for example an injector valve), it will quickly cause overheating and unnecessary wear. Also, because diesel engines require large amounts of compression to operate, water in the fuel system can be very dangerous as water cannot be compressed and may cause considerable engine damage. Similarly, clogged injectors may allow the corresponding cylinder to run dry and damage the engine (e.g. burn a hole in the piston, melt the piston, or seize the engine).

Designs to prolong filter life and/or prevent filter clogs have been introduced. One device of this type is shown in U.S. Pat. No. 5,244,571 titled Fuel Filter Assembly with Heater, issued on Sep. 14, 1993 having Church et al., listed as inventors (the '571 patent), the entirety of which is hereby incorporated by reference. Briefly, the '571 patent describes a fuel filter assembly for filtering diesel fuel including: a filter head, a spin on replaceable element and a collection bowl removable from the element. The element includes a casing with a turned-in edge portion at a lower end. An adaptor ring is supported on said edge portion inside the element and includes an annular threaded portion. The collection bowl has an outer peripheral wall with an annular threaded portion engaging the threaded portion of the adaptor ring. The outer peripheral wall of the bowl has an annular shoulder abutting the turned-in edge portion of said casing to clamp said casing between the adaptor ring and the bowl, when the bowl is attached to the element. A seal between the shoulder and the casing further serves to hold the element and the bowl in fluid tight relation.

The current application utilizes a fuel filter in combination with a pressure sending unit called a fuel protector or FUPRO™. FUPRO™ is system and method of protecting common rail light and medium duty diesel engines from internal damage due to clogged fuel filters. For example, if a factory installed fuel filter becomes clogged on engines, the injector pump will suck contaminants through their filters and deposition of these same contaminants may occur in the injectors. This results in either the injectors being clogged or stuck open. When the injectors are stuck open, the engine will either be very difficult to start or will not start. Clogged filters may allow the corresponding cylinder to run dry and can lead to engine damage such as a hole in a piston or a melted piston. Either of these situations are costly to the vehicle owner/operator. For example, a complete injection system can run from about $8,000 to about $20,000 (in 2008 dollars). If the pistons are damaged the repair cost may be increased an additional range of about $12,000. One embodiment of the FUPRO™ system should not negate or bypass a factory installed fuel line filter unit on a vehicle. The FUPRO™ system does add a filter clog warning in addition to the factory installed fuel filter. A second embodiment of the FUPRO™ premium kit system uses a fuel filter in combination with a pressure gauge or vacuum gage depending on the fuel flow mechanism associated with the engine. A third embodiment of the FUPRO™ basic kit system uses a fuel filter in combination with at flow pressure/vacuum warning light. A fourth embodiment of the FUPRO™ system utilizes a fuel filter in combination with a vehicle shut-down system to prevent engine damage. A fifth embodiment of this invention utilizes a fuel filter in combination with a “limp-in” mode, which allows the operator to operate the vehicle in a diminished capacity to prevent damage to the vehicle until the clogged fuel filter is replaced. A sixth embodiment may be applicable to vehicles having at least an auxiliary fuel filter. In these vehicles, a sending unit and gauge can be used in conjunction with the auxiliary fuel filter unit being fitted between the auxiliary filter and the engine mounted filter. One skilled in the art will appreciate that the invention described herein can be adapted to many different engine types having various fuel delivery systems without departing from the scope and spirit of the invention. Additionally, one skilled in the art appreciates that similar warning devices can be used to alert the driver when the fuel filter is becoming clogged without departing from the scope and spirit of the invention.

### SUMMARY

One aspect of the current invention is a fuel filter assembly having a pressure sending unit for filtering and monitoring fuel and fuel pressure for diesel engines and the like comprising a filter head, a spin-on element, collection bowl, pressure sending unit, and a means for indicating a decrease in fuel pressure (e.g. gauge, warning light, shut off valve, or the like). The filter head is fastened to an engine or other suitable structure by flange, bolts, and supports the fuel filter assembly by monitoring fuel pressure by utilizing a pressure sending unit in fluid communication with an outlet port on the filter head. Preferably, filter head is a die cast head and includes therein typical inlet port, outlet port, and connected respectively thereto, inlet chamber and outlet chamber. Filter head is a generally circular structure having a flat annular mounting surface. The filter head may further comprises vent ports, vacuum switch ports or both, which are in fluid communication with outlet ports and return check valve ports that are in fluid communication with inlet ports. Still further, filter head is in fluid communication with a pressure sending unit, which is in electrical communication with a pressure monitoring device or similar warning system.

### BRIEF DESCRIPTION OF THE DRAWINGS

FIG. 1 is a perspective view of a fuel system showing the configuration of the current invention in relation to the fuel transfer pump and the factory installed fuel filter;

FIG. 2A is a schematic top and side view of a first embodiment of a fuel filter assembly with pressure sending unit of the invention;

FIG. 3 is a schematic side view of a pressure sending unit and a schematic view of a pressure gauge of the invention;

### DETAILED DESCRIPTION OF THE PREFERRED EMBODIMENTS

It will be readily apparent to one skilled in the art that various substitutions and modifications may be made in the invention disclosed herein without departing from the scope and spirit of the invention.

The term “a” or “an” as used herein in the specification may mean one or more. As used herein in the claim(s), when used in conjunction with the word “comprising”, the words “a” or “an” may mean one or more than one. As used herein “another” may mean at least a second or more.

The term “fuel filter” as used herein refers to a mechanism in the fuel line that screens out dirt, contaminants, or/and other particles from the fuel.

The term “injectors” and “injector pump” as used herein may refer to part of a fuel injection is a system for mixing fuel with air in an internal combustion engine, which has become a primary system used in automotive engines. A fuel injection system is designed and calibrated specifically for the type(s) of fuel it will handle: gasoline (petrol), Autogas (LPG, also known as propane), ethanol, methanol, methane (natural gas), hydrogen or diesel, however, the majority of fuel injection systems are for gasoline or diesel applications. With the advent of electronic fuel injection (EFI), the diesel and gasoline hardware has become similar. For example, EFI's programmable firmware has permitted common hardware to be used with multiple different fuels. For gasoline engines, carburetors were the predominant method to meter fuel before the widespread use of fuel injection. However, a wide variety of injection systems have existed since the earliest usage of the internal combustion engine.

Diesel engines require a method to store and deliver fuel to the engine. Because diesel engines rely on injectors, which are precision components with extremely tight tolerances and very small injection hole(s), the fuel delivered to the engine must be extremely clean and free from contaminants. The fuel system should not only deliver the fuel but also ensure its cleanliness. This is usually accomplished using an in-line filter.

Additionally, a diesel engine's fuel system is more complex than the fuel system on a simple gasoline engine because the fuel generally serves two purposes. The first is to obviously supply the fuel to run the engine; the other is to act as a coolant to the injectors. To meet this second purpose, diesel fuel is kept continuously flowing through the engines' fuel system at a flow rate much higher than required to simply run the engine. The excess fuel is routed back to the fuel pump or the fuel storage tank depending on the application. One of ordinary skill in the art will recognize that at least a second fuel filter system having a system to alert the operator can reduce or prevent costly damage to the injectors or the engine due to clogged fuel lines or injectors.

There are many different types of fuel delivery systems that will benefit for the instant invention. One skilled in the art will appreciate that the instant invention design can be modified to be utilized in most engine fuel delivery systems without diverging from the spirit and scope of the invention. For example, an overview of a fuel delivery and fuel injection systems are described in a publication by Toyota Motor Company, titled “EIF#3—Fuel delivery and Fuel Injection Control,” which the entire reference is contained in the information disclosure and incorporated by reference herein.

As one skilled in the art will appreciate, the primary functional difference between carburetors and fuel injection is that fuel injection atomizes the fuel by forcibly pumping it through a small nozzle under high pressure, while a carburetor relies on the vacuum created by intake air rushing through it to add the fuel to the airstream. The fuel injector is only a nozzle and a valve: the power to inject the fuel comes from farther back in the fuel supply, from a pump or a pressure container, which is one reason a clogged fuel filter system can be detrimental to the proper function of an engine, especially a diesel.

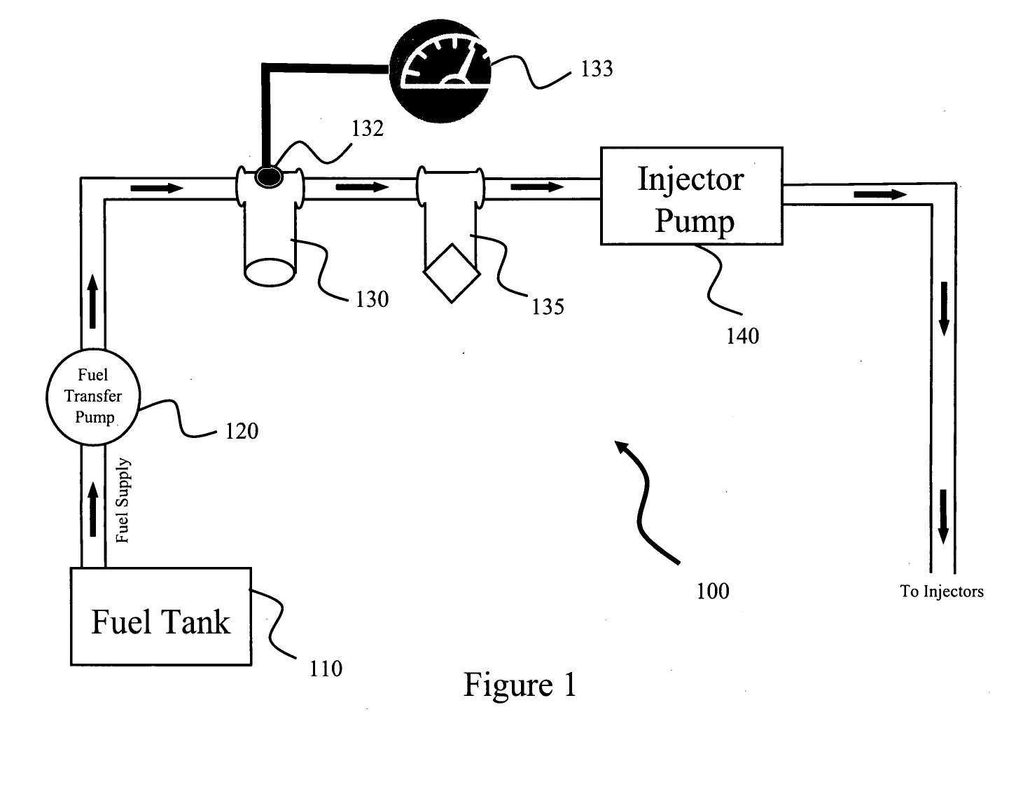

Now referring to FIG. 1 in this application, a general fuel supply system for a typical diesel engine is depicted in schematic form with the invention incorporated 100. This system is shown comprising fuel tank 110, fuel transfer pump 120, a first standard fuel filter 135, injection pump 140 that feeds into a plurality of injectors (not shown), a second fuel filter assembly 130 with pressure sending unit 132 and gauge 133 of the instant invention is also shown. Typical fuel lines are interconnected among the various components of the system with, for example, fuel line connected to a fuel filter inlet port may have various bleed lines providing a fuel return path from each of the injectors to the fuel tank. Bleed lines may also be present but not depicted as returning fuel from injection pump to fuel tank as a part of the fuel system. Not depicted in FIG. 1 but understood as comprising a part of the fuel system, are pressure lines between the injection pump and each of the injectors which supply fuel to the diesel engine.

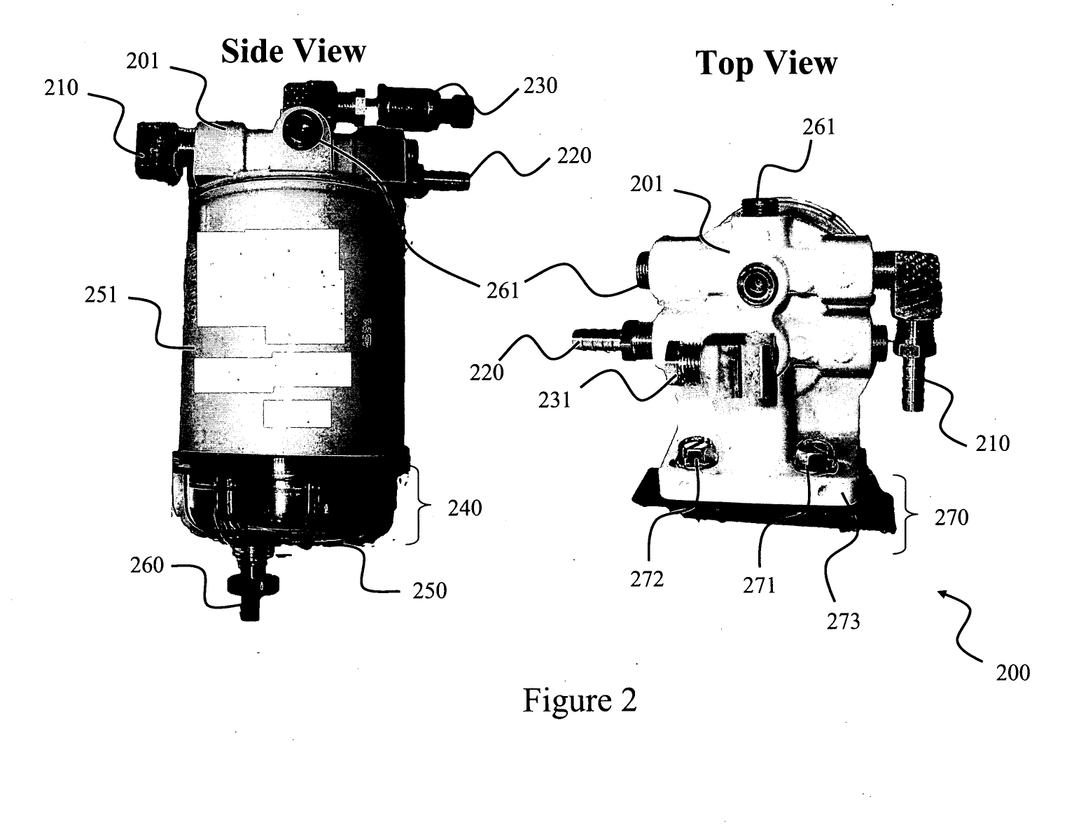

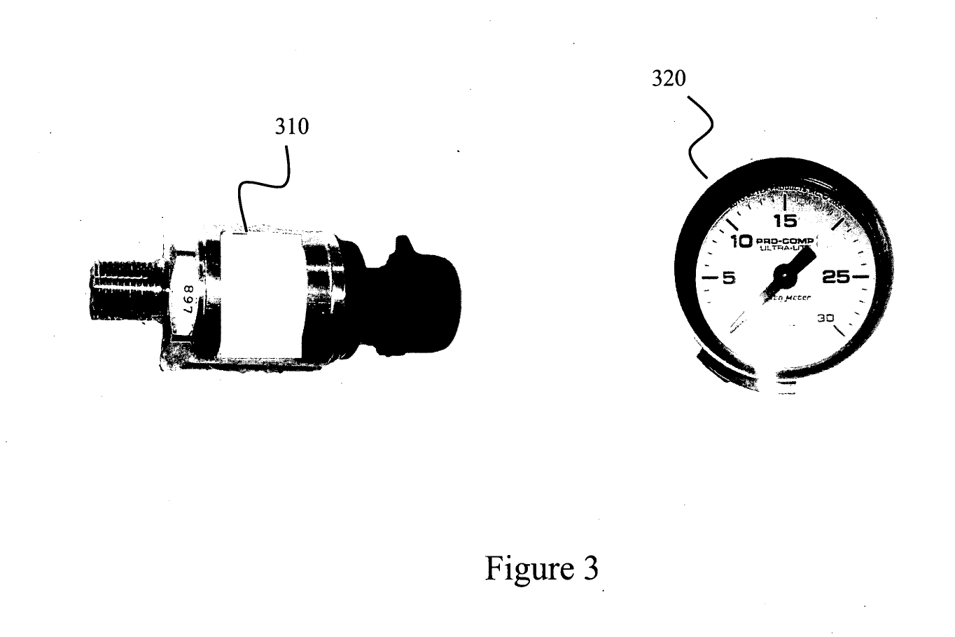

Now referring to FIG. 2. A side and top view fuel filter assembly having a pressure sending unit for filtering and monitoring fuel and fuel pressure for diesel engines and the like comprises a filter head 201, a spin-on element 251 and collection bowl 240. The filter head is fastened to an engine or other suitable structure by flange 270 and bolts 271, 272 and supports the entire fuel filter assembly with pressure sending unit 200. Preferably, filter head 201 is a die cast head and includes therein typical inlet port 210, outlet port 220, and connected respectively thereto, inlet chamber and outlet chamber. Filter head 201 is a generally circular structure having a flat annular mounting surface 273. The filter head 201 may further comprises vent ports, vacuum switch ports or both, which are in fluid communication with outlet ports and return check valve ports that are in fluid communication with inlet ports. Still further, filter head 201 is in fluid communication with a pressure sending unit 230, which is in electrical communication with a pressure monitoring device or similar warning system (not shown). In a specific embodiment, a Racor/Parker spin-on replacement Element Part No R60S fuel filter having a 2 micron filter was utilized. Similar filters having a range of 2-5 microns can be utilized used. FIG. 3 shows an Auto Meter 4360 Ultra-Lite Full Sweep Electric Fuel Pressure Gauge that reads from 0 PSI to 30 PSI having a pressure sending unit having a stepper motor meter movement with full sweep, including ⅛ NPT sender

Many techniques have been developed for the measurement of pressure and vacuum. Instruments used to measure pressure are called pressure gauges or vacuum gauges. For example, a manometer could also be referring to a pressure measuring instrument, usually limited to measuring pressures near to atmospheric. The term manometer is often used to refer specifically to liquid column hydrostatic instruments.

A vacuum gauge is used to measure the pressure in a vacuum, which is further divided into two subcategories: high and low vacuum (and sometimes ultra-high vacuum). The applicable pressure range of many of the techniques used to measure vacuums has an overlap. One of ordinary skill in the art will understand that the overlap of techniques used to measure fuel pressures and engine vacuum in a fuel line are incorporated in this application without contradictory diverging from the spirit and scope of this invention.

### EXAMPLES

The following examples are included to demonstrate preferred embodiments of the invention. It should be appreciated by those of skill in the art that the techniques disclosed in the examples that follow represent techniques discovered by the inventor to function well in the practice of the invention, and thus can be considered to constitute preferred modes for its practice. However, those of skill in the art should, in light of the present disclosure, appreciate that many changes can be made in the specific embodiments that are disclosed and still obtain a like or similar result without departing from the spirit and scope of the invention.

Fuel contamination is a common problem. The primary responsibility of preventing engine performance problems and equipment damage associated with contaminated fuel usually falls upon the end user. These responsibilities include the proper and timely replacement and servicing of the filters; selection of the fuel source, grade, and blend; and use of heaters, separators, and additives as required. Fuel filters capture unwanted contaminants from the fuel. Left unchecked, these contaminants may cause serious and expensive damage to many system components including pumps, lines, and injectors. Fuel contaminants have many sources. Most sources are external to the fuel system itself, that is, most contaminants come with the fuel that is delivered to the fuel tank. Diesel fuel is generally “clean” when it comes from the refinery. Contaminants in diesel fuel are generally introduced in fuel storage systems through mixing, transferring, and storage.

Fuel filters naturally increase resistance to the flow of fuel as they go about their job of removing unwanted contaminants from the fuel system. Fuel systems, unlike lube systems, do not have the opportunity for bypass flow and consequently, as flow through the fuel filter decreases, decreased performance of the fuel system and the engine will result. Fuel filters will become restricted or plugged over their life, which is an expected result. A thorough investigation of the filter and the fuel source should be conducted anytime a fuel filter is suspected of delivering less than its expected life. Some common contaminants found in today's fuels might include:

Water—is the greatest concern because it is the most common form of contaminant. Water may be introduced into the fuel supply during fueling when warm, moisture laden air condenses on the cold metal walls of fuel storage tanks or from poor housekeeping practices. The effects of water in diesel fuel can be serious. Water can cause a tip to blow off an injector, or reduce the lubricity of the fuel which can cause seizure of close tolerance assemblies such as plungers.

Once in the system, water can be removed by using in-line water separating filters or devices. Long term prevention of problems associated with water in fuel is best accomplished by obtaining fuel from reputable suppliers capable of providing high quality fuel. Further, fuel tanks should be kept well filled to prevent condensation, and fuel should be drawn from the top of a storage tank if possible, as water is heavier than diesel fuel and tends to settle to the bottom of storage tanks. Tanks can also be kept free of water with continuous off-line or “kidney-loop” filtration/separation.

Fungus and Bacteria These microorganisms live in water and feed on the hydrocarbons found in fuel. These organisms are known as a hydrocarbon-utilizing microorganism (or “HUM bug”), causing microbial corrosion. Humbugs create active and multiplying colonies that can spread throughout a fuel system and quickly plug a fuel filter. The fuel filter will have a slime coating over the surface of the media, dramatically reducing the service life of the filter. Bacteria may be any color, but is usually black, green or brown. Draining the system will reduce microbial activity, but will not eliminate it. The only way to eliminate microbial growth once it has started is to clean and treat the system with a biocide.

Wax Wax can be a desirable a source of energy in fuel, control in cold weather operation is needed. Wax crystals form as a result of cold temperature precipitation of paraffin. Temperatures below a fuel's cloud point will result in wax precipitation and filter plugging. To prevent plugged filters due to wax formation, the cloud point of fuel must be at least +12° Celsius (+22° F.) below the lowest outside temperature. Fuel suppliers blend diesel fuel based on local anticipated cold weather conditions. Particular attention should be given to diesel fuel purchased outside your local area. For example, fuel purchased in the West or South may not be suitable for operating conditions in the Midwest or North.

Asphaltines are components of asphalt that are generally insoluble and are generally present to some extent in all diesel fuel. These black, tarry asphaltines are hard and brittle, and are made up of long molecules. Fuel with a high percentage of asphaltines will drastically shorten the life of a fuel filter.

Sediment and other solids—often get into fuel tanks and cause problems. Most sediment can be removed by settling or filtration. Fuel filters designed for specific applications will remove these harmful contaminants before they cause further system wear and damage.

Plugged filters will develop as the filter works to remove unwanted contaminants from the fuel system. Filter manufacturers design fuel filters to provide the level of filtration protection specified or required by the OEM manufacturer. As stated previously fuel filter replacement is usually completed on a time schedule, however, time schedules do not alert users to immediate fuel source contamination problems that clog fuel filters in a non-time dependent manner, which will eventually impact the life of other, more expensive fuel system components.

Clean fuel is essential for efficient, full-power engine performance. Most newly refined fuel is clean, however, between the time the fuel leaves the refinery and enters the engine's fuel tanks, it should be handled carefully to avoid possible contamination that can prematurely plug fuel filters and cause even further, more serious damage within the engine's fuel system. The instant invention can be used to alert the user of more immediate fuel problems.

### Example 1

A diesel engine is an internal combustion engine which operates using the Diesel cycle. These engines were invented in 1892 by German engineer Rudolf Diesel, it was

A 2003 Dodge Diesel Pickup was used to test the ability of the instant invention to monitor fuel pressure during engine operation. The general fuel supply system for the 2003 Dodge diesel comprised a fuel tank, a fuel transfer pump, an OEM fuel filter, injection pump that feeds into a plurality of injectors. One embodiment of the invention comprises a 2 micron Racor-Parker fuel filter (Part No. R60S) and an Autometer 4360 sending unit and pressure gauge, as shown in FIG. 2 and FIG. 3. As shown in the figure the fuel pressure gauge sending unit is mounted in one of the filters outlet ports. The sending unit leads to a fuel pressure gauge mounted, preferably in the drivers side “A” pillar of the cab of the vehicle. One reason for mounting the gauge in this position is to make it as visible as possible to the driver. The filter is mounted on the frame rail of the vehicle and cut into the fuel supply line, again between the transfer pump and the injector pump. The optimum range of the filter is in the range of about 2-5 microns with the preferred range being about 2 microns. Vehicle manufacturers typically use a 6-7 micron filter. The instant invention assembly was installed between the fuel transfer pump and the OEM fuel filter using Gates Spec 4319D Viton line making it usable with bio-diesel, or equivalent thereof. Standard flex fuel lines can also be utilized. This configuration indicated that the fuel filter needed to be replaced when the fuel pressure dropped under about 5 pounds of pressure, as indicated on the Autometer 4360 gauge. Although a pressure gauge was used, one of ordinary skill in the art understands that various pressure monitoring systems may also be used to alert the operator that the fuel filter needs to be cleaned or replaced (e.g. warning light, limp mode, cut off switch, etc).

Furthermore, the spin-on filter portion may be substituted with any comparable spin-on filter/water separator that will fit the filter head and has a similar micron rating (e.g. in the range of about 2-5 microns). Filters having a micron rating of about less than 2 microns will not allow diesel fuel to flow efficiently. In contrast, filters having a micron rating greater than 5 will be too coarse and not remove harmful contaminations. The flex line filters and seals should be compatible with bio-diesel fuel. The gauge can be a universal electronic fuel pressure gauge having a rating to match that of the transfer pump.

Additionally, the instant invention also offers a method of diagnosing transfer pump problems. For example, if the fuel pressure is low and the fuel filter is replaced without having the fuel pressure return to a normal range (e.g. in the range of about 5 to 30 pounds), this may be an indication that the fuel transfer pump is bad or needs to be replaced. This can reduce diagnostic costs.

### Example 2

One of ordinary skill in the art understands vehicles having engines other than ones found in Example 1 experience similar problems with clogged fuel filters that cause costly engine malfunctions. As such, the instant invention can be modified for different engines designs. Although each engine's needs vary to a certain extent, modifications are within the spirit and scope of the instant invention.

Vacuum Fuel Supply: There are at least two manufactures that utilize a vacuum fuel supply system and a 2 micron final filter on their current production engines (i.e. GM and Isuzu). Although not wanting to be bound by theory, one modification would be to utilize a vacuum gauge, wherein, the vacuum gage sensor could be mounted in the supply line between the final filter and the engine. For the GM and Isuzu example, the max vacuum is about 12″ of Hg. Similarly, highway diesel trucks can utilize a mounting design that is similar to the GM/Isuzu model, but the max vacuum will vary with engine series and manufacture.

Similar to Example 1, Ford/IHC light duty trucks use a 4 micron final filter and a pressure supply system, which would require only a pressure gauge. The sensor would be mounted in the fuel supply line between the final filter and the engine. The minimum pressure required would be known to one skilled in the art as supplied to the user.

### Example 3

A tractor is a vehicle specifically designed to deliver a high tractive effort at slow speeds, for the purposes of hauling a trailer or machinery used in agriculture or construction. Most commonly, the term is used to describe the distinctive farm vehicle: agricultural implements may be towed behind or mounted on the tractor, and the tractor may also provide a source of power if the implement is mechanized. Another common use of the term, “tractor unit”, describes the power unit of a semi-trailer truck, tractors, agriculture, and industrial equipment. As such, some of these machines use pressure fuel supply systems and some use vacuum. Most of this equipment appears to have sufficient filter quality, so additional filters may not be required. However, the pressure sender or the vacuum source should be mounted after the secondary filter and the pressure or vacuum.

### Example 4

One specific embodiment includes a fuel supply system for monitoring the condition of a fuel filter on a engine. This system comprises (a) a fuel line; (b) a fuel tank; (c) a fuel transfer pump; (d) a first fuel filter assembly; (e) a pressure sending unit; (f) a second fuel filter assembly; and (g) an injection pump feeding into a plurality of injectors. In this embodiment, the fuel line interconnects each component of the fuel supply system such that the fuel tank is in fluid communication with the plurality of injectors through the fuel transfer pump; the first fuel filter assembly having the pressure sending unit; the second fuel filter assembly; and the injector pump feeding into a plurality of injectors. The preferred engine is a diesel engine and the preferred indicator device is capable of alerting an operator of the diesel engine when the pressure sending unit sends a signal from the first fuel filter assembly indicating that cleaning or replacement is necessary, wherein the signal is about less than about 20 psi, preferably less than 10 psi and more preferably less than about 5 psi. The indicator device can be one of many types of devices (e.g. a light, an audible sound producing device; a pressure gauge having symbols or demarcations indicating when the first fuel filter should be replaced), and one of ordinary skill in the art will understand that many indicator devices can be used without diverting from the spirit and scope of this invention. The preferred indicator device comprises an Auto Meter 4360 Ultra-Lite Full Sweep Electric Fuel Pressure Gauge that reads from 0 PSI to about 30 PSI having a pressure sending unit with a stepper motor meter movement with full sweep, including ⅛ NPT sender. One of ordinary skill in the art will recognize that some engines using higher supply line pressures may require a pressure gauge rated for those higher pressures (e.g. up to or greater than 100 PSI). Similarly, the first fuel filter assembly may be a filter having a pore size in the range of about 2-5 microns with the preferred range being about 2 microns, or functional equivalent thereof. For example, the preferred first fuel filter assembly comprises a Racor/Parker spin-on replacement Element Part No R60S fuel filter having a 2 micron filter, however, other models can be used with similar specifications.

A second embodiment involves a method for monitoring the condition of a fuel filter on a diesel engine. This method comprises installing a first fuel filter having a pressure sending unit with a fuel pressure monitoring device in a fuel line between a fuel transfer pump and a second fuel filter; and positioning the fuel pressure monitoring device in a location that can be observed by an operator of the diesel engine. This embodiment indicates that the first fuel filter is in fluid communication with the fuel transfer pump and the second fuel filter; the first fuel filter has a micron rating in the range of about 2-5 microns with the pressure sending unit capable of discriminating fuel pressures in the range of about 0 to about 30 pounds. Additionally, the method further comprises replacing the first fuel filter when the fuel pressure monitoring device alerts the operator of the diesel engine when the fuel pressure is less than about 15 psi, preferably less than about 10 psi, and more preferably less than about 5 psi. Although the fuel pressure monitoring device can alert the operator of the diesel engine in many ways (e.g. light, an audible sound producing device; a pressure gauge having symbols or demarcations indicating when the fuel pressure is less than about 5 psi) the preferred indicator device comprises an Auto Meter 4360 Ultra-Lite Full Sweep Electric Fuel Pressure Gauge that reads from 0 PSI to 30 PSI having a pressure sending unit with a stepper motor meter movement with full sweep, including ⅛ NPT sender, or equivalent thereof.

As mentioned above, there are many techniques that have been developed for the measurement of pressure and vacuum in a system. Instruments used to measure pressure are called pressure gauges or vacuum gauges. Because some diesel engines use vacuum rather than pressure to make fuel flow, a method for monitoring the condition of a fuel filter on a diesel engine using a vacuum gauge is a third embodiment of this invention. The method utilizes installing a first fuel filter in a fuel line between a fuel tank and a second fuel filter, installing a vacuum gauge sensor with a monitoring device in the fuel line between a second fuel filter and the engine; and positioning the fuel vacuum gauge monitoring device in a location that can be observed by an operator of the diesel engine. In this embodiment, the first fuel filter is in fluid communication with the fuel tank and the second fuel filter; the first fuel filter has a micron rating in the range of about 2-5 microns, and the vacuum gauge monitoring device capable of discriminating engine vacuum about 0″ of Hg to about 15″ of Hg. Additionally, the method replaces the first fuel filter when the fuel vacuum gauge monitoring device alerts the operator of the diesel engine when the fuel vacuum is about 12″ of Hg or preferably about 8″ of Hg. The preferred first fuel filter assembly comprises a filter having a pore size in the range of about 2-5 microns with the preferred range being about 2 microns. The more preferred first fuel filter assembly comprises a Racor/Parker spin-on replacement Element Part No R60S fuel filter having a 2 micron filter, or functional equivalent thereof.

### REFERENCES CITED

The entire content of each of the following U.S. patent documents and published references are hereby incorporated by reference.
1) Fuel Delivery and Injection Control—Toyota Motor Sales, U.S. A
2) How diesel engines work. http://www.howstuffworks.com/diesel.htm/printable

### U.S. PATENT DOCUMENTS

U.S. Pat. No. 5,244,571 issued on Sep. 14, 1993 with Church et al. listed as inventors.
U.S. Pat. No. 4,502,956 issued on March, 1985 with Wilson et al. listed as inventors.

What is claimed is:

1. A fuel supply system for monitoring the condition of a fuel filter on a engine comprising:
(a) a fuel line;
(b) a fuel tank;
(c) a fuel transfer pump;
(d) a first fuel filter assembly;
(e) a pressure sending unit;
(f) a second fuel filter assembly; and
(g) an injection pump feeding into a plurality of injectors;
wherein the fuel line interconnects each component of the fuel supply system such that the fuel tank is in fluid communication with the plurality of injectors through the fuel transfer pump; the first fuel filter assembly having the pressure sending unit; the second fuel filter assembly; and the injector pump feeding into a plurality of injectors.

2. The fuel supply system of claim 1, wherein the engine is a diesel engine

3. The fuel supply system of claim 2, further comprising:
an indicator device capable of alerting an operator of the diesel engine when the pressure sending unit sends a signal from the first fuel filter assembly indicating that cleaning or replacement is necessary, wherein the signal is about less than about 20 psi.

4. The fuel supply system of claim 3, wherein the signal indicates fuel pressure is less than about 10 psi.

5. The fuel supply system of claim 3, wherein the signal indicates fuel pressure is less than about 5 psi.

6. The fuel supply system of claim 3, wherein the indicator device comprises a light, an audible sound producing device; a pressure gauge having symbols or demarcations indicating when the first fuel filter should be replaced.

7. The fuel supply system of claim 6, wherein the indicator device comprises an Auto Meter 4360 Ultra-Lite Full Sweep Electric Fuel Pressure Gauge that reads from 0 PSI to 30 PSI having a pressure sending unit with a stepper motor meter movement with full sweep, including ⅛ NPT sender.

8. The fuel supply system of claim 2, wherein the first fuel filter assembly comprises a filter having a pore size in the range of about 2-5 microns with the preferred range being about 2 microns.

9. The fuel supply system of claim 8, wherein the first fuel filter assembly comprises a Racor/Parker spin-on replacement Element Part No R60S fuel filter having a 2 micron filter.

10. A method for monitoring the condition of a fuel filter on a diesel engine comprising:
(a) installing a first fuel filter having a pressure sending unit with a fuel pressure monitoring device in a fuel line between a fuel transfer pump and a second fuel filter,
(b) positioning the fuel pressure monitoring device in a location that can be observed by an operator of the diesel engine
wherein, the first fuel filter is in fluid communication with the fuel transfer pump and the second fuel filter; the first fuel filter has a micron rating in the range of about 2-5 microns with the pressure sending unit capable of discriminating fuel pressures in the range of about 0 to about 30 pounds.

11. The method of claim 10, further comprising:
(c) replacing the first fuel filter when the fuel pressure monitoring device alerts the operator of the diesel engine when the fuel pressure is less than about 15 psi.

12. The method of claim 10, further comprising:
(c) replacing the first fuel filter when the fuel pressure monitoring device alerts the operator of the diesel engine when the fuel pressure is less than about 10 psi.

13. The method of claim 10, further comprising:
(c) replacing the first fuel filter when the fuel pressure monitoring device alerts the operator of the diesel engine when the fuel pressure is less than about 5 psi.

14. The method of claim 13, further comprising:
(d) utilizing the first fuel filter having a fuel pressure monitoring device alerts the operator of the diesel engine using a light, an audible sound producing device; a pressure gauge having symbols or demarcations indicating when the fuel pressure is less than about 5 psi, wherein the indicator device comprises an Auto Meter 4360 Ultra-Lite Full Sweep Electric Fuel Pressure Gauge that reads from 0 PSI to 30 PSI having a pressure sending unit with a stepper motor meter movement with full sweep, including ⅛ NPT sender.

15. A method for monitoring the condition of a fuel filter on a diesel engine comprising:
(a) installing a first fuel filter in a fuel line between a fuel tank and a second fuel filter,
(b) installing a vacuum gauge sensor with a monitoring device in the fuel line between a second fuel filter and the engine;
(c) positioning the fuel vacuum gauge monitoring device in a location that can be observed by an operator of the diesel engine;
wherein, the first fuel filter is in fluid communication with the fuel tank and the second fuel filter; the first fuel filter has a micron rating in the range of about 2-5 microns, and the vacuum gauge monitoring device capable of discriminating engine vacuum about 0″ of Hg to about 5″ of Hg.

16. The method of claim 15, further comprising:
(d) replacing the first fuel filter when the fuel vacuum gauge monitoring device alerts the operator of the diesel engine when the fuel vacuum is about 12″ of Hg.

17. The method of claim 15, further comprising:
(d) replacing the first fuel filter when the fuel vacuum gauge monitoring device alerts the operator of the diesel engine when the fuel vacuum is about 8″ of Hg.

18. The method of claim 15, wherein the first fuel filter assembly comprises a filter having a pore size in the range of about 2-5 microns with the preferred range being about 2 microns.

19. The method of claim 18, wherein the first fuel filter assembly comprises a Racor/Parker spin-on replacement Element Part No R60S fuel filter having a 2 micron filter.
